(19) United States
(12) Patent Application Publication
(10) Pub. No.: US 2017/0282121 A1
(43) Pub. Date: Oct. 5, 2017

(54) POTABLE WATER MAKING APPARATUS FOR PERSONAL USE

(71) Applicant: DeftIO LLC, San Francisco, CA (US)

(72) Inventor: Manjirnath Chatterjee, San Francisco, CA (US)

(21) Appl. No.: 15/479,270

(22) Filed: Apr. 4, 2017

Related U.S. Application Data
(60) Provisional application No. 62/317,946, filed on Apr. 4, 2016.

(51) Int. Cl. B01D 53/26; C02F 1/00; C02F 1/32; C02F 1/02; F25B 21/02; B01D 53/30

(52) U.S. Cl. CPC B01D 53/265; F25B 21/02; B01D 53/30; C02F 1/32; C02F 1/02; C02F 1/001

(57) ABSTRACT

A potable water making apparatus includes a thermoelectrical cooling plate, air intake, and a separator. The thermoelectrical cooling plate is operable with electrical power to form a cool surface. The air intake guides the air from a surrounding across an area of the cooling plate, and the separator drives condensation from the cool surface to a reservoir.

### RELATED APPLICATIONS

This application claims priority to Provisional U.S. Patent Application No. 62/317,946, filed on Apr. 4, 2016; the aforementioned priority application being hereby incorporated by reference in its entirety.

### BACKGROUND

Existing water filtration systems exist to create water for personal consumption. Such filtration systems typically use filter material (e.g., carbon filters, membrane based filters) or external heat source. These types of devices require water as a source, in order to create cleansed water for consumption.

Some existing devices also create water from air delivery, but these devices often require high electrical consumption.

### BRIEF DESCRIPTION OF THE DRAWINGS

FIG. 1A and FIG. 1B illustrate a respective front and side view of a potable water making apparatus, according to one or more embodiments.

FIG. 1C illustrates an alternative example of a potable water making apparatus.

### DETAILED DESCRIPTION

Examples described herein include a potable water making apparatus which uses a cooled surface to condense water vapor from the atmosphere in to liquid water. In some examples, the apparatus also exposes the liquid water to a purification process, before releasing the water to a storage container.

According to some examples, a potable water making apparatus applies an active air intake against a thermoelectrical cooling surface to create condensation on the cooling surface. A separation mechanism may periodically trigger separation of the condensation from the cooling surface. When separated, the condensation may be collected in a reservoir, and subjected to one or more purification processes.

According to examples, the separation mechanism is triggered intermittently as needed, depending on the moisture content of the air. In drier climates, the separation mechanism may be less frequent, so as to conserve the amount of energy needed to create a potable supply.

In some examples, the thermoelectric cooling medium can be implemented by a Peltier plate, which utilizes electrical current to form opposing warm and cold surfaces.

Still further, in some examples, the separation mechanism may be provided by a Sonic agitator, a piezoelectric mechanism, or a solenoid. The mechanisms may electrically or mechanically drive condensation off of a plate (e.g. Peltier plate) being utilized for thermal electrical cooling.

In some variations, the purification process can be implemented using pulsed light (e.g., ultraviolet light), or a process to heat then cool the water.

Some examples provide that the apparatus is operable using energy from the environment. For example, the apparatus may be operated using a solar cell (or collection thereof), wind, or through geothermal energy.

According to examples, the potable water making apparatus may be implemented as a standalone assembly or device, sufficiently small dimensions to be carried in an individual's backpack.

A potable water making apparatus includes a thermoelectrical cooling plate, air intake, and a separator. The thermoelectrical cooling plate is operable with electrical power to form a cool surface. The air intake guides the air from a surrounding across an area of the cooling plate, and the separator drives condensation from the cool surface to a reservoir.

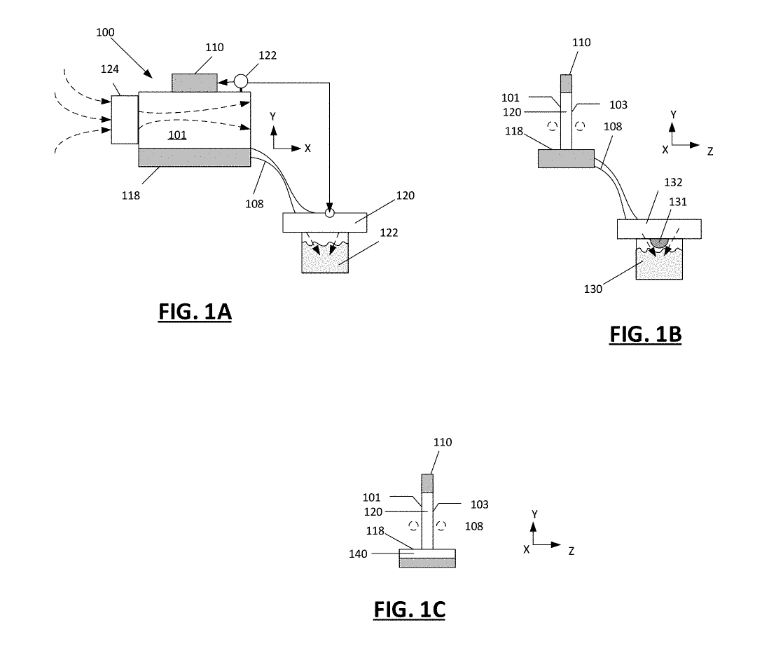

FIG. 1A and FIG. 1B illustrate a respective front and side view of a potable water making apparatus, according to one or more embodiments. With reference to FIG. 1A, a potable water making apparatus 100 includes a separator 110 (or separation mechanism), a base 118, a thermoelectric cooling plate 120, a power source 122, and an air intake 124. In operation, the power source 122 can power multiple components of the apparatus 100, including the thermoelectric cooling plate 120 and air intake 124. When powered, the thermoelectric cooling plate 120 can form opposing warm and cool surfaces. From a perspective shown with FIG. 1, a side 101 may be warmed with the application of power input from the power source 122, and a side 103 (shown in FIG. 1B) may be cooled to collect condensation.

With further reference to an example of FIG. 1A, the power source 122 may power the air intake 124 to actively draw and guide air across a length (e.g., shown by the X axis) of the surface 101 of the thermoelectric cooling plate 120. The effect of the passage of air over the thermoelectric cooling plate 120 is that condensation forms on the cool side 103 (see FIG. 1B). Depending on implementation, the air intake 124 may be positioned to be either the front or rear of the air flow that is being directed across the surface 101. The air intake 124 may correspond to a fan or pump that actively guides air in the direction shown by the X axis. The active guidance provided by the air intake 124 may be proportional to the amount of condensation that is sought to be formed and collected.

The separator 110 may be intermittently triggered to cause the separation of condensation on the cool side of 120. Depending on implementation, the separator 110 may be provided by, for example, a piezo electric pulser, a solenoid, a sonic agitator or other vibrational mechanism. When triggered, the separator 110 can create a mechanical or electrical effect that serves to separate water condensed on the cool side 103 of the thermoelectric cooling plate 120, so that additional condensation may be formed on the cool side 103.

FIG. 1B illustrates a top-bottom orientation of the apparatus 100, according to one or more examples. The thermoelectric cooling plate 120 may be aligned vertically, so as to extend in the Y-axis, with air received in the direction that is orthogonal to the paper. When aligned vertically with gravity, the condensation can be collected on the cool side 103 of the thermoelectric cooling plate 120, and periodically or intermittingly coalesced by the triggering of the separator 110.

With further reference to FIG. 1A and 1B, the condensation may be coalesced at or near the base 118. In some examples, the coalesced water can be collected in a conduit 108 (e.g., hose) and directed to a reservoir 130. A purification mechanism 132 may be employed to purify the water at the reservoir 130. In some examples, the purify mechanism 130 includes pulsed light, such as provided by an ultraviolet source 131, which as represented by FIG. 1A, may be powered by the power source 122.

FIG. 1C illustrates an alternative implementation in which the base 118 integrates a reservoir 140 for collection of water. A purifier (e.g., pulsed UV light) may also be integrated within the base to purify the water as it is stored.

With reference to examples of FIG. 1A through FIG. 1C, the power source may be implemented by, for example, a solar cell or battery. The purification mechanism can also, as an alternative or variation, utilize a filtering mechanism.

With further reference to examples described, the thermoelectric cooling plate may be implemented as a Peltier plate, or alternatively, as a stack of Peltier plates. The particular alignment (e.g., vertical or standing up) may be varied, as may dimensions. In variations, the surface of the thermoelectric cooling plate may also be ribbed, or featured to increase surface area and/or facilitate the movement of condensation.

In examples described, the apparatus 100 may be dimensioned to be portable. The amount of water which may be created can range, depending on humidity, but even in dry climates, the apparatus 100 can create eight ounces of water over the length of the day.

While certain embodiments have been described above, it will be understood that the embodiments described are by way of example only. Accordingly, this disclosure should not be limited based on the described embodiments. Rather, the scope of the disclosure should only be limited in light of the claims that follow when taken in conjunction with the above description and accompanying drawings.

What is claimed is:

1. A potable water making apparatus comprising:
a thermoelectrical cooling plate that is operable with electrical power to form a cool surface;
an air intake to guide air from a surrounding across an area of the cooling plate; and
a separator to drive condensation from the cool surface to a reservoir.

2. The apparatus of claim 1, wherein the thermoelectrical cooling plate is a Peltier plate.

3. The apparatus of claim 1, wherein the separator is a sonic agitator.

4. The apparatus of claim 1, wherein the separator is a piezo pulser.

5. The apparatus of claim 1, wherein the separator is a solenoid.

6. The apparatus of claim 1, further comprising:
a purification mechanism provided with the reservoir to purify the collected condensation.

7. The apparatus of claim 6, wherein the purification mechanism includes an ultraviolet light.

8. The apparatus of claim 1, further comprising multiple thermoelectric cooling plates which are stacked.
